(19) United States
(12) Patent Application Publication
(10) Pub. No.: US 2016/0174147 A1
(43) Pub. Date: Jun. 16, 2016

(54) ACCESS POINT SELECTION FOR MOBILE DEVICE POSITIONING

(71) Applicant: QUALCOMM Incorporated, San Diego, CA (US)

(72) Inventors: Jiajian Chen, San Jose, CA (US); Saumitra Mohan Das, Santa Clara, CA (US); Yin Chen, Campbell, CA (US); Hui Chao, San Jose, CA (US)

(21) Appl. No.: 14/569,437

(22) Filed: Dec. 12, 2014

(51) Int. Cl. H04W 48/20; H04W 64/00

(52) U.S. Cl. CPC H04W 48/20; H04W 64/006

(57) ABSTRACT

Methods, systems, computer-readable media, and apparatuses for reducing a set of access points to be used for mobile device positioning are presented. In some embodiments, a subset of access points may be selected from a set of access points. A trial set of access points may be generated by removing the subset of access points from the set of access points. A coverage quality may be determined for the trial set of access points. In response to determining that the coverage quality of the trial set of access points exceeds a threshold coverage quality, the subset of access points may be removed from the set of access points.

### BACKGROUND

Aspects of the disclosure relate to reducing a set of access points to be used for mobile device positioning.

In various approaches to mobile device positioning, a mobile device can measure a received signal strength indication (RSSI) or round trip time (RTT) of each access point (AP) signal received by the mobile device. Using the measured RSSI and/or RTT values, the mobile device can determine its distance from each AP from which a signal is received. Based on the calculated distances from APs and known locations of APs, the mobile device can estimate its position.

When a mobile device is located in an environment with many APs, it may be possible for a mobile device to determine its position using data from a set of APs that is fewer in number than the total number of APs detectable by the mobile device. Using a reduced set of APs for positioning may allow the mobile device to save power that would otherwise be expended by the mobile device to measure RSSI and/or RTT for each AP signal received by the mobile device, particularly when many more APs are detectable by the mobile device than are needed for positioning. Additionally, using a reduced set of APs for positioning may reduce the amount of data a mobile device receives from a server indicating APs to be used for positioning.

### BRIEF SUMMARY

Certain embodiments are described that reduce a set of access points to be used for mobile device positioning.

In one example, a method for reducing a set of access points to be used for mobile device positioning is disclosed. The method includes selecting a subset of access points from a set of access points. The subset of access points includes one or more access points but less than all access points of the set of access points. A trial set of access points is generated by removing the subset of access points from the set of access points. A coverage quality for the trial set of access points is determined. If the coverage quality of the trial set of access points exceeds a threshold coverage quality, the subset of access points is removed from the set of access points.

In another method for reducing a set of access points to be used for mobile device positioning, a subset of access points among a plurality of subsets of access points is selected to be a current subset. A trial set of access points is generated by removing the current subset from the set of access points. A number of positioning-capable locations is determined using the trial set of access points. The number of positioning-capable locations is stored. If fewer than all of the plurality of subsets of access points have been selected, the current subset is iterated to the next subset. A subset of access points from the plurality of subsets of access points is determined for which the stored number of positioning-capable locations is highest. A reduced set of access points is generated by removing the subset of access points from the set of access points.

In another example, a mobile device is described. The mobile device includes a processor, a computer-readable medium coupled to the processor, and one or more programs. The one or more programs are stored in the computer-readable storage device and configured to be executed by the processor. The one or more programs include instructions for generating a list of a plurality of access points passively scanned by the mobile device. The one or more programs additionally include instructions for receiving heat map data from a server. The heat map data includes data for a reduced set of access points. The reduced set of access points includes fewer access points than the number of the plurality of access points of the list.

In a further example, a non-transitory computer-readable storage medium is described. The non-transitory computer-readable storage medium includes a computer program product of computer-readable instructions for performing a method of reducing a set of access points to be used for mobile device positioning. The method includes selecting a subset of access points from a set of access points. The subset of access points includes one or more access points but less than all access points of the set of access points. A trial set of access points is generated by removing the subset of access points from the set of access points. A coverage quality for the trial set of access points is determined. If the coverage quality of the trial set of access points exceeds a threshold coverage quality, the subset of access points is removed from the set of access points.

### BRIEF DESCRIPTION OF THE DRAWINGS

Aspects of the disclosure are illustrated by way of example.

FIG. 1 illustrates a terrestrial network system that may be implemented for determining a position of a mobile device, according to some embodiments.

FIGS. 2A-2D illustrate an exemplary change in coverage area resulting from reducing a number of APs used for positioning.

FIG. 3 illustrates an exemplary configuration of locations at which positioning capability may be determined.

FIG. 4A illustrates operations for reducing a set of access points to be used for mobile device positioning, according to a first embodiment.

FIG. 4B illustrates operations for receiving a reduced set of access points to be used for mobile device positioning.

FIG. 5A shows an illustrative graph of coverage ratios corresponding to numbers of access points in reduced sets of APs.

FIG. 5B shows an illustrative graph of the first derivative of coverage ratios corresponding to numbers of access points in reduced sets of APs.

FIG. 6 illustrates operations for reducing a set of access points to be used for mobile device positioning, according to a second embodiment.

FIG. 7 illustrates an example of a computing system in which one or more embodiments may be implemented.

FIG. 8 illustrates an example of a mobile device in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

In an environment with many APs, a subset of APs may be selected for use in mobile device positioning. Various approaches may be used to determine a reduced set of APs to use for positioning. Each approach may involve removing a subset of one or more APs from the set of APs associated with a particular environment and determining the quality of AP signal coverage for the environment in the absence of the removed APs. Subsequent subsets of APs may be removed from the set of APs until the quality of signal coverage reaches a desired quality level.

A server may generate a reduced set of APs by removing APs from a set of APs associated with an environment. The server may provide the reduced set of APs to a mobile device for use determining a position of the mobile device.

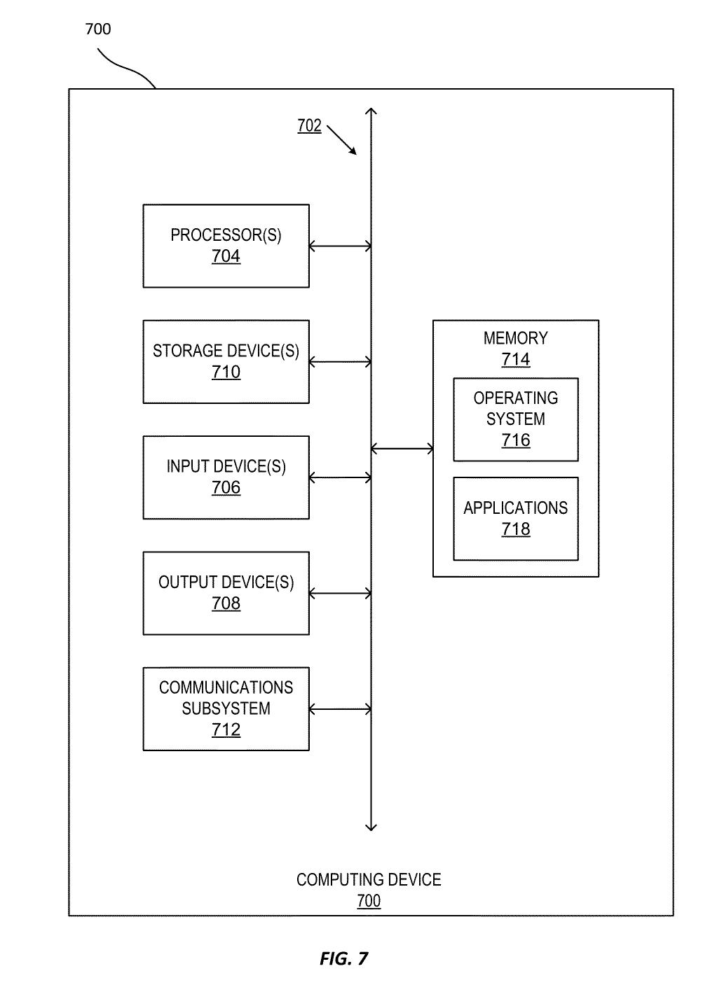

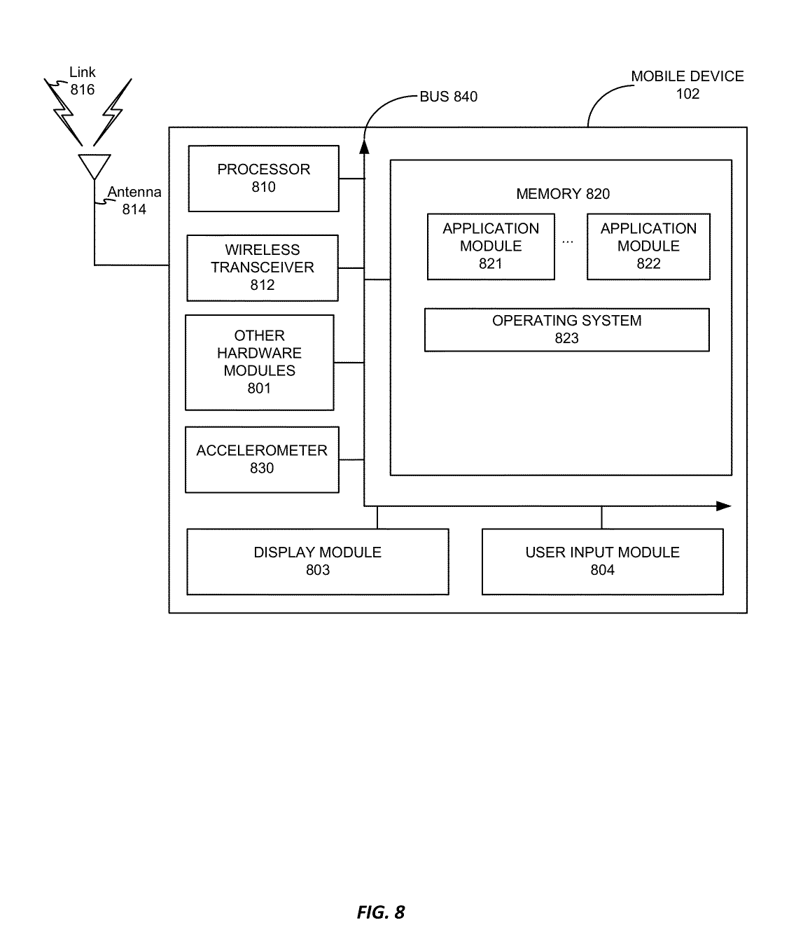

As used herein, “mobile device” may refer to any mobile electronic computing device. The mobile device may be capable of measuring a signal broadcast by an access point (AP) or other positioning system component. Examples of mobile devices may include smartphones, laptop computers, portable gaming systems, specialized electronic devices for positioning, or any other such electronic device. Additional examples of mobile devices and computing devices may be disclosed in relationship to FIGS. 7-8 below.

As used herein, “access point” (AP) may refer to a device connected as part of a wireless local area network (WLAN) or other network that may be accessed by a user's mobile device. Such a network may provide wireless access to a broader network using a particular wireless networking protocol such as an IEEE 802.11 protocol, Bluetooth, or any other wireless communication method.

As used herein, “horizontal dilution of precision” (HDOP) may refer to a quality of AP configuration relative to a mobile device for positioning purposes. An HDOP at the mobile device decreases as the configuration of APs relative to a mobile device improves the potential for accurate positioning. HDOP may be determined by a mobile device or by a server using data provided to the server by the mobile device.

As used herein, “received signal strength indicator” (RSSI) may refer to strength of a signal transmitted from an AP as measured or estimated at a particular location. For example, an RSSI may be a signal strength measured at a mobile device. In another example, an RSSI at a particular grid point may be estimated by a server.

As used herein, “round trip time” (RTT) may be an amount of time needed for a signal to travel from a first node to a second node of a network and for an acknowledgement of the signal to be transmitted from the second mode to the first node. For example, an RTT may be an amount of time during which a signal is transmitted from a mobile device to an AP and during which the mobile device receives an acknowledgement from AP that the signal was received. RTT may be determined by a mobile device or by a server using data provided to the server from a mobile device or access point.

As used herein, a “positioning-capable” location may refer to a location at which data available to a mobile device allows the mobile device to determine its position with a desired degree of accuracy. For example, a positioning-capable location may be a location at which a determined or estimated HDOP is below a threshold value (e.g., 1.5). A position capable location may be a location at which an RSSI exceeding a threshold signal strength (e.g., −85 dB) is detectable from at least a minimum number of APs (e.g., three APs). A position capable location may be a location at which an RTT between an AP and a location is estimated to be below a threshold amount of time (e.g., 30,000 ns) for at least a minimum number of APs (e.g., three APs). In some embodiments, a positioning-capable location is a location at which multiple criteria are met, e.g., at which HDOP and RSSI criteria as described above are met. It will be recognized that other criteria, such as other measurements in positioning, may be used to for identifying positioning-capable locations. A location at which positioning capability is determined may be, e.g., a grid point of a set of grid points.

As used herein, “coverage quality” is an indication of the availability of data usable by a mobile device for determining position with a desired degree of accuracy. For example, a coverage quality may be a ratio of a number of positioning-capable locations for a partial set of access points in an area to a number of positioning-capable locations for a set of access points in the area, where the set of access points includes the partial set of access points. The partial set of access points may be a trial set of access points in which a selected set of access points has been removed on a trial basis from the set of access points. In another example, a coverage quality may be a predetermined threshold value indicating an acceptable level of coverage. In a further example, a coverage quality may be a number of positioning-capable locations in an area.

As used herein, “coverage ratio” may be a ratio of a number of positioning-capable locations for a partial set of access points in an area to a number of positioning-capable locations for a set of access points in the area, where the set of access points includes the partial set of access points. The partial set of access points may be a reduced set of access points in which a selected set of access points has been removed from the set of access points.

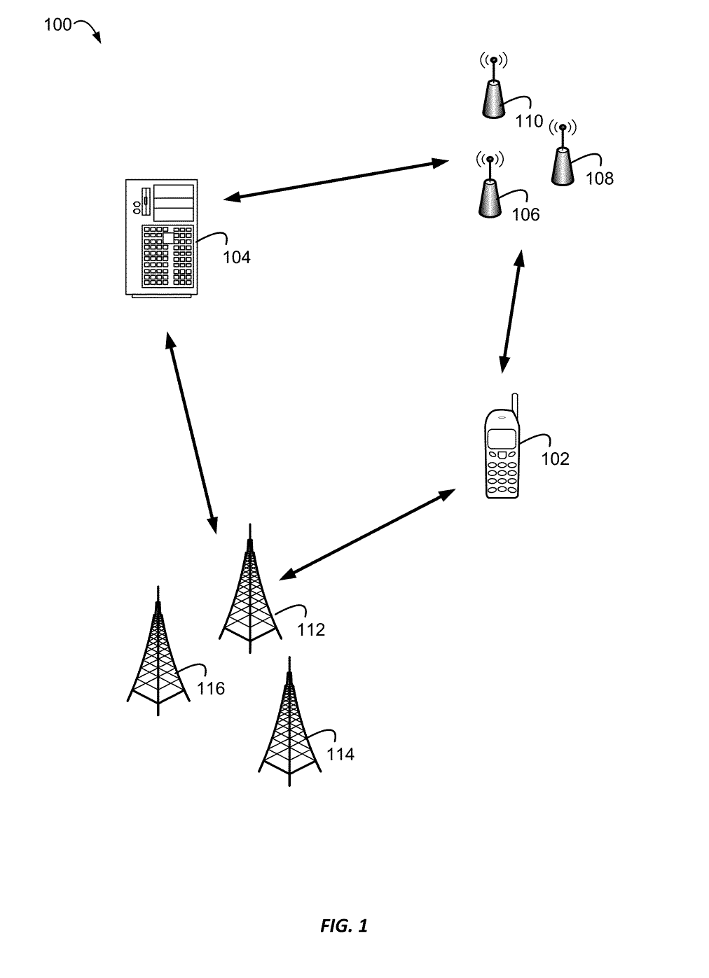

Embodiments described herein may be implemented using any positioning network such as a terrestrial network system, described with regard to FIG. 1.

FIG. 1 illustrates one potential implementation of a terrestrial network system that may be implemented for determining a position of a mobile device, according to some embodiments. Terrestrial network system 100 may include mobile device 102, server computer 104, and multiple APs, for example, AP 106, AP 108, and AP 110.

Server computer 104 may comprise one or more computing devices capable of processing location data and communicating with mobile device 102 regarding position data. Server computer 104 may access data from a database (not shown). The database may be stored on one or more computing devices of server computer 104, or may be stored on one or more devices that are remote from and communicatively coupled to server computer 104. Server computer 104 may be located on site in an area for which position data is being provided, or may be located remotely from such an area.

Access points 106, 108, 110 may be communicatively coupled to server computer 104 and any other available infrastructure computing devices by wired or wireless connections. Access points 106, 108, 110 may communicate with mobile device 102 using WLAN connectivity (e.g., Wi-Fi and the like) or other wireless connectivity.

In some embodiments, terrestrial network system 100 includes multiple base stations, e.g., base stations 112, 114, and 116. Terrestrial network 100 may provide voice and/or data communication for a number of mobile devices including mobile device 102 via base stations 112, 114, 116. In some embodiments, data communications received by mobile device via base stations 112, 114, 116 may include position data. Communications between mobile device 102 and base stations 112, 114, 116 may occur via a cellular network, such as CDMA, LTE, WiMAX, and the like.

Terrestrial network system 100 may be used to determine a position for mobile device 102 using signals transmitted from one or more APs 106, 108, 110. Environments in which terrestrial network system 100 may be used to determine a position for mobile device 102 may include indoor environments, walkable distance environments, and other environments having a similar scale, such as: shopping malls, airports, sports arenas, educational campuses, commercial campuses, convention centers, and the like.

Mobile device 102 may send a request for assistance data to server 104. The request for assistance data may include a location context identifier (LCI). An LCI may be a string or other identifier to indicate a building, campus, or other environment, or a portion of an environment such as a wing or room. Server 104 may respond to the request for assistance data by sending assistance data to mobile device 102. The assistance data may include a list of identifiers for a plurality of APs to be used by mobile device 102 for positioning. The listed APs may be APs associated with an LCI. In some embodiments, server 104 may determine an LCI using data provided by mobile device 102, such as RSSI data usable to identify APs detectable by mobile device 102. The assistance data may include a flag indicating that the list of APs is a reduced set of APs.

Mobile device 102 may receive and/or observe position data from the APs identified in the assistance data. Position data observed by mobile device 102 from APs 106, 108, 110 may include, e.g., RSSI and/or RTT.

Mobile device 102 may use the position data to estimate distances between mobile device 102 and multiple APs, e.g., APs 106, 108, 110. Mobile device 102 may use the estimated distances and known location of the APs to perform trilateration or other position analysis techniques to estimate the position of mobile device 102. In some embodiments, mobile device 102 may additionally be capable of using positioning data received from base stations 112, 114, 116 and/or GPS data to determine a position of mobile device 102.

In some embodiments, mobile device 102 may provide received and/or observed position data to server 104. Server 104 may use the position data to estimate a distance between mobile device 102 and multiple APs 106, 108, 110. Server 104 may use the estimated distances and known locations of the APs to perform trilateration or other position analysis techniques to estimate the position of mobile device 102. Server 104 may provide position data indicating the position of mobile device 102 to mobile device 102. For example, server 104 may transmit location coordinates of mobile device 102 to mobile device 102.

In another example, mobile device 102 or server 104 may compare position data, such as RSSI and/or RTT for multiple APs 106, 108, 110, to a heat map that provides expected signal strengths for the multiple APs 106, 108, 110 at various positions (e.g., a grid of points) in an environment. Mobile device 102 or server 104 may determine the location of mobile device 102 using pattern matching or another analysis technique. For example, pattern matching may include finding location coordinates at which RSSIs for the multiple APs 106, 108, 110 as determined from a heat map most closely match the RSSIs observed by mobile device 102.

Heat map information corresponding to APs 106, 108, 110 may be collected using different techniques. For example, a dedicated device may be used to measure signal strength at certain locations and send the measured data to a location server. Server 104 may store the heat map information corresponding to and provide the information to mobile device 102. The heat map information may be used to determine locations at which positioning may not be accurately performed.

In some embodiments, a crowd-sourcing scheme may be used to generate heat map information. For example, a plurality of mobile devices 102 may participate in crowdsourcing. The participating mobile devices 102 may receive and/or observe position data from APs 106, 108, 110. The participating mobile devices 102 may transmit the position data to server 104. Server 104 may use the received position data to determine position data including a heat map, positions of APs 106, 108, 110, RSSI information for APs 106, 108, 110 at various locations relative to APs 106, 108, 110, etc. The position data determined by server 104 may be used for determining a position of mobile device 102.

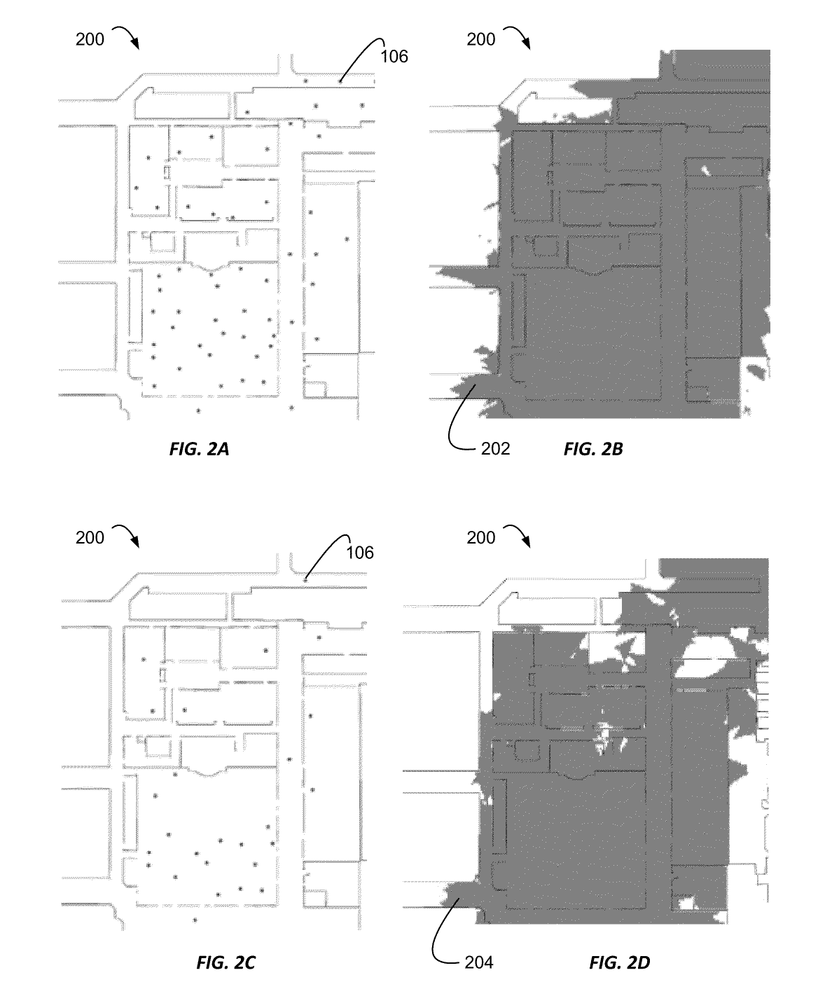

FIGS. 2A-2D illustrate an exemplary change in coverage area resulting from reducing a number of APs used for positioning. In FIG. 2A, a set of APs 106 corresponding to an illustrative environment 200 is shown. In FIG. 2A, 53 APs are shown.

The shaded portion of FIG. 2B indicates a coverage area 202 within environment 200 when the set of 53 APs shown in FIG. 2A are used. Coverage area 202 indicates positioning-capable locations within environment 200. For example, server 104 may estimate HDOP and RSSI values at various locations within environment 200 using information about the locations of APs 106 within environment 200.

FIG. 2C shows a reduced set of APs 106 corresponding to environment 200. In FIG. 2C, 27 APs are shown.

The shaded portion of FIG. 2D indicates a coverage area 204 within environment 200 when the reduced set of 27 APs shown in FIG. 2C are used. Coverage area 204 indicates positioning-capable locations within environment 200 for the reduced set of APs. For example, server 104 may estimate HDOP and RSSI values at various locations within environment 200 using information about the locations of the reduced set of APs 106 within c environment 200.

As can be seen from comparing coverage area 204 of FIG. 2D with coverage area 202 of FIG. 2B, a set of APs associated with environment 200 can be reduced from 53 APs to 27 APs with only minor reduction of coverage area. When a number of APs used for mobile device positioning can be reduced such that an acceptable coverage area remains, it may be desirable to reduce the number of APs used for positioning in order to reduce the power usage of the mobile device for measuring AP signals. Reducing the number of APs used for mobile device positioning can also reduce the amount of data transmitted from server 104 to mobile device 102, such as data indicating a list of APs to be used by mobile device 102 for position determination. One example of an environment 200 can include an indoor or outdoor venue.

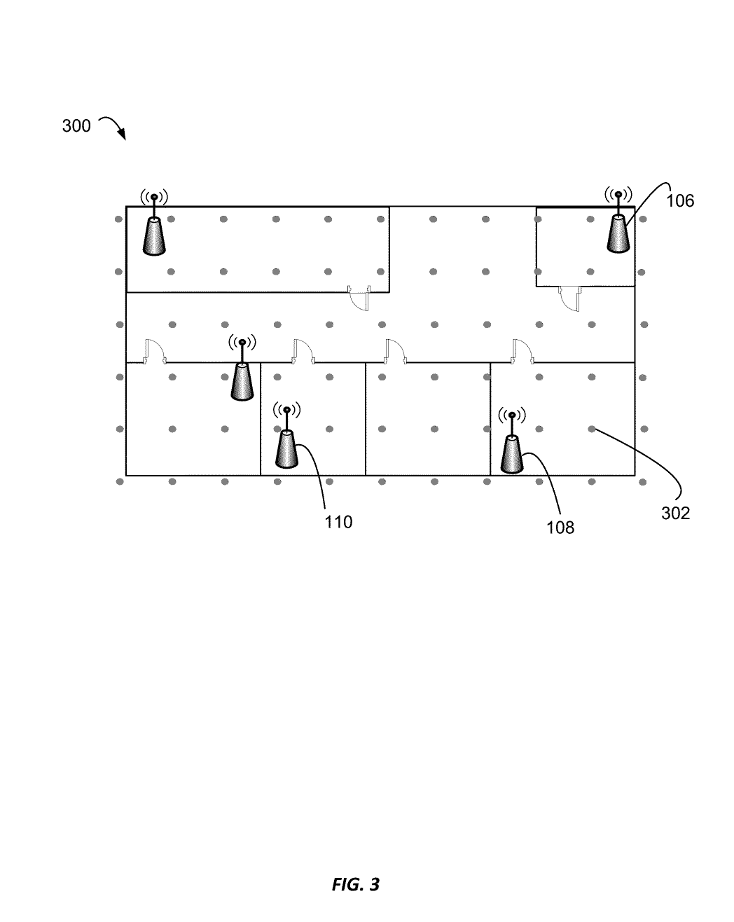

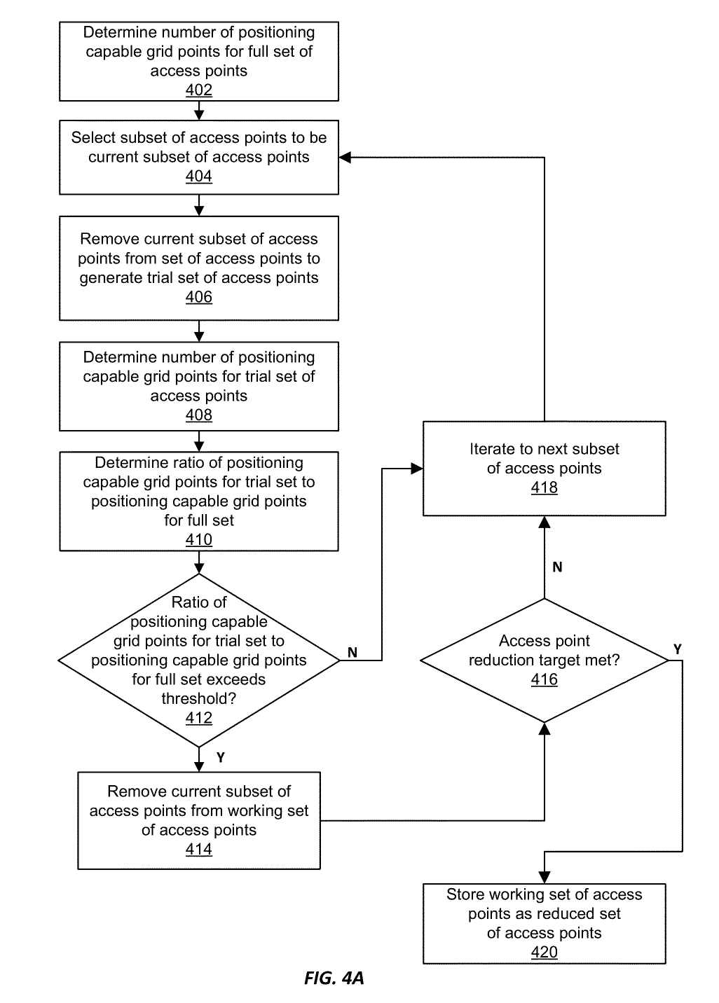

Determining a coverage area such as coverage area 202 and coverage area 204 may involve determining positioning capability at a number of locations within an environment such as environment 200. For example, positioning capability may be described at a set of grid points as discussed below with regard to FIG. 3.

FIG. 3 illustrates an exemplary configuration of locations at which positioning capability may be determined. For each grid point 302 of a set of grid points, server 104 may determine whether grid point 302 is a positioning-capable location. A set of grid points 302 may be spaced such that there is a distance between each grid point, for example one foot between each grid point, two feet between each grid point, etc. The grid points 302 may be established relative to an environment, such as an environment indicated by map 300. A grid point 302 may be a positioning-capable location when one or more criteria are met, e.g., server 104 determines that an estimated HDOP at grid point 302 falls below a threshold HDOP value, server 104 determines that at least three APs are “visible” (i.e., an estimated RSSI from at least three APs exceeds a threshold signal strength value at grid point 302), server 104 determines that an estimated round trip time (RTT) at grid point 302 from at least three APs falls below a threshold value at grid point 302 (i.e., an estimated RTT indicates that at least three APs are sufficiently close to grid point 302), etc., or any combination thereof.

Positioning capability is generally determined relative to a given set of APs. For example, as illustrated in FIG. 3, APs used for HDOP, RSSI, and/or RTT determinations may include APs such as those shown at 106, 108, 110. In some embodiments, a determination that grid point 302 is a positioning-capable location requires that an estimated HDOP at the grid point fall below a threshold HDOP value, that at least three APs are visible from grid point 302, and/or that at least three APs are sufficiently close to grid point 302.

Below, two approaches are described for removing a subset of access points from a set of access points.

In a first approach, the subset of APs may be a randomly selected plurality of APs. A trial set of APs may be created by removing the subset of APs from the full set of APs. Coverage quality may be determined for the trial set of APs. The coverage quality may be based on a determined number of positioning-capable locations when the subset of APs is removed from the full set of APs. If the coverage quality is determined to be adequate, a reduced set of APs may be generated by removing the subset of APs from the full set of APs. If the coverage quality is determined to be inadequate, a new subset of APs may be selected for removal from the set of APs to form a new trial set of APs. New subsets of APs may be selected and trialed until a trial set of APs that produces adequate coverage quality is determined. After a reduced set of APs is generated, additional subsets of APs may be trialed for removal from the reduced set until a target for the reduced set of access points is reached.

In a second approach, a series of trial sets may be generated by sequentially removing single APs from the full set of APs. Coverage quality may be determined for each trial set of APs. The trial set that causes the least reduction in the quality level of AP signal coverage may be determined and the AP that was removed from that trial set may be removed from the set of APs to form a working set of APs. Subsequently, APs may be removed one at a time from the working set of APs to form a second series of trial sets. Coverage quality may be determined for each trial set of the second series of trial sets. The trial set of the second series that causes the least reduction in the quality level of AP signal coverage may be determined and the AP that was removed from that trial set may be removed from the working set of APs to form a new working set of APs (the new working set being further reduced from the previous working set). APs can be removed from the set of APs to form working sets of APs in this manner until a target for the reduced set of APs is reached.

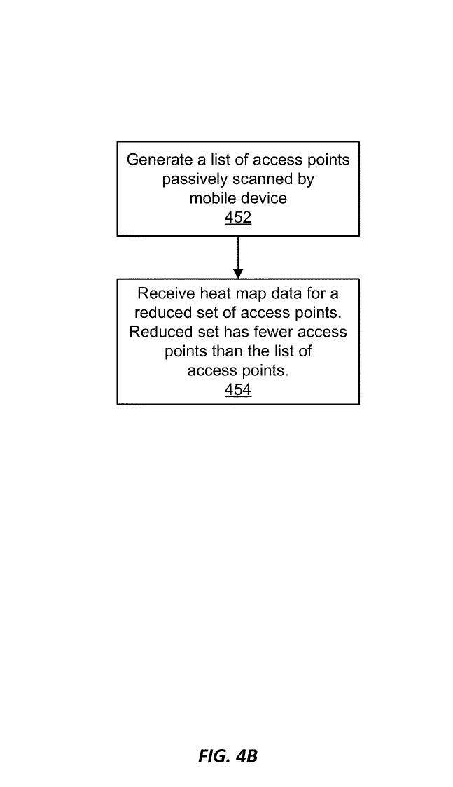

FIG. 4A illustrates operations for reducing a set of access points to be used for mobile device positioning compared to a total number of available access points for an area, according to a first embodiment. Operations 402-420 may be performed by, e.g., server 104.

At operation 402, a number of positioning-capable locations associated with an area may be determined. An area may be an environment, LCI, an indoor or outdoor venue (which may include one or more LCIs), or other area. A set of APs may be associated with the area and may represent all APs associated with the area. For example, the set of APs may include 25 APs identified as AP1-AP25. A set of locations may be a set of grid points associated with the area. A number of positioning-capable grid points may be less than or equal to the total number of grid points in the set of grid points.

The number of positioning-capable locations may be a number of grid points 302 at which positioning criteria, e.g., HDOP, visible AP criteria, and/or close AP criteria are met, for example, if an estimated HDOP at a grid point 302 is below a threshold HDOP value, at least three APs are estimated to have an RSSI exceeding a threshold level at grid point 302, and/or at least three APs are estimated to have an RTT that falls below a threshold level at grid point 302.

At operation 404, a subset of APs may be selected from a set of APs. The subset of APs may be one or more APs of the set of APs but less than all of the APs in the full set of APs. The subset of APs may be referred to as a current subset of APs.

In some embodiments, the subset of APs may be a randomly (or pseudorandomly) selected AP or set of APs.

In other embodiments, subsets of APs may be selected sequentially, such as one AP at a time. For example, a first AP from a sequential list of APs may be selected as a first current subset, a second AP from the sequential list of APs may be selected as a second current subset, and so on. In another example, a first set of multiple APs, such as the first five APs of a sequential list of APs, may be selected as a first current subset; a second set of multiple APs, such as five APs following the first five APs of the sequential list of APs, may be selected as a second current subset; and so on. In alternative embodiments, the subset of APs may be selected randomly, pseudorandomly, or sequentially, or any combination thereof.

In some embodiments, particular APs may be excluded from any subset of APs that may be removed from the set of APs. For example, an AP may be located in or near to a location within an environment, such as a corridor or other highly trafficked area, where users are particularly likely to rely on mobile positioning. Such APs may be flagged, e.g., in association with an AP identifier stored by server 104, to indicate that server 104 should exclude the AP from any subset of APs being trialed for potential removal from the set of APs. In other words, in such embodiments, such APs may be important for positioning and hence all trial sets of APs will include such APs.

At operation 406, the current subset of APs may be removed from the set of APs to generate a trial set of APs. In the first iteration, the current subset of APs may be removed from the set of all APs. In subsequent iterations, the current subset of APs may be removed from the set of all APs or from a working set of APs from which one or more APs have been previously removed. For example, if a set of APs includes 25 APs identified as AP1-AP25 and the current subset of APs includes a randomly selected set of APs identified as AP5, AP9, and AP17, the trial set of APs will include AP1-AP4, AP6-AP8, AP10-AP16, and AP18-AP25.

At operation 408, a number of positioning-capable locations (e.g., positioning-capable grid points as described with respect to FIG. 3) is determined for the trial set of APs. In an illustrative example, when APS, AP9, and AP17 are removed from the set of APs such that only AP1-AP4, AP6-AP8, AP10-AP16, and AP18-AP25 remain in the trial set, the number of positioning-capable locations may be lower than the number of positioning-capable locations determined for AP1-AP25 at operation 402.

At operation 410, it is determined whether a ratio the number of positioning-capable locations determined for the trial set of APs to the number of positioning-capable locations determined for the full set of APs exceeds a threshold. For example, if operation 408 determined that 95 grid points are positioning-capable locations when the trial set of APs (in the current example, the trial set is the set of APs referred to as AP1-AP4, AP6-AP8, AP10-AP16, and AP18-AP25) is used and operation 402 determined that 100 grid points are positioning-capable locations when the full set of APs (e.g., AP1-AP25) is used, the ratio determined at operation 410 will be 0.95. It is understood that a grid point is “positioning-capable” in reference to some criteria, for example, a location where an HDOP is below a threshold, an RSSI exceeds a threshold signal strength from at least a minimum number of APs, an RTT between an AP and a location is estimated to be below a threshold amount of time for at least a minimum number of APs, a combination of criteria such as both RSSI and/or RTT above or below a threshold and an HDOP below a threshold, and/or any combination thereof. Hence whether a grid point is positioning-capable can be based upon some criteria, which may be based upon a desired accuracy that can be received from the mobile device 102 (for example, an application on the mobile device 102).

At operation 412, it is determined whether the ratio determined at operation 410 exceeds a threshold. The threshold may be a minimum acceptable coverage quality. For example, the threshold may be a minimum ratio in a range of 0.6-0.99, such as a minimum ratio in range of 0.8-0.95, e.g., a minimum ratio of 0.9. When the ratio determined at operation 410 exceeds the threshold, flow may proceed to operation 414. When the ratio determined at operation 410 does not exceed the threshold, flow may proceed to operation 418.

At operation 414, the current subset of APs may be removed from the set of APs to form a working set of APs. When a ratio as determined at operation 410 exceeds a threshold ratio, the current subset of APs may not be needed to provide adequate coverage quality, so the current subset can be removed from the full set of APs without substantial adverse effect to positioning in the environment. In an illustrative example, after operation 414, a working set of APs may include AP1-AP4, AP6-AP8, AP10-AP16, and AP18-AP25 (because current subset AP5, AP9, and AP17 was removed from the full set of APs AP1-AP25). In subsequent iterations, a new current subset of APs may be removed from the working set of APs.

At operation 416, it may be determined whether a target for the reduced set of access points is met by the current working set of APs. If the target is met, flow may proceed to operation 420. If the target is not met, flow may proceed to operation 418.

A target for the reduced set of access points may be a target coverage ratio. A coverage ratio may be a ratio of a number of positioning-capable locations for the reduced set of access points to a number of positioning-capable locations for the full set of access points. When a current coverage ratio exceeds a target coverage ratio, additional APs may be removed from the reduced set of access points. For example, if a target coverage ratio is 0.93, and the current coverage ratio is 0.95, flow may proceed to operation 418 so that additional subsets of APs may be selected for removal from the reduced set of APs.

A target for the reduced set of access points may be a target number of APs. When a number of APs in the reduced set of access points exceeds a target number of access points, additional APs may be removed from the reduced set of access points. For example, if a target number of APs is 15, and the number of APs in the reduced set is 22, flow may proceed to operation 418 so that additional subsets of APs may be selected for removal from the reduced set of APs. In some embodiments, a target number of APs may be 3-300 APs, such as 10-100 APs, e.g., 15 APs.

A target for the reduced set of access points may be determined using coverage ratio drop off point, which is a point at which the coverage ratio begins a rapid decline in a graph of coverage ratios corresponding to numbers of access points in reduced sets of APs.

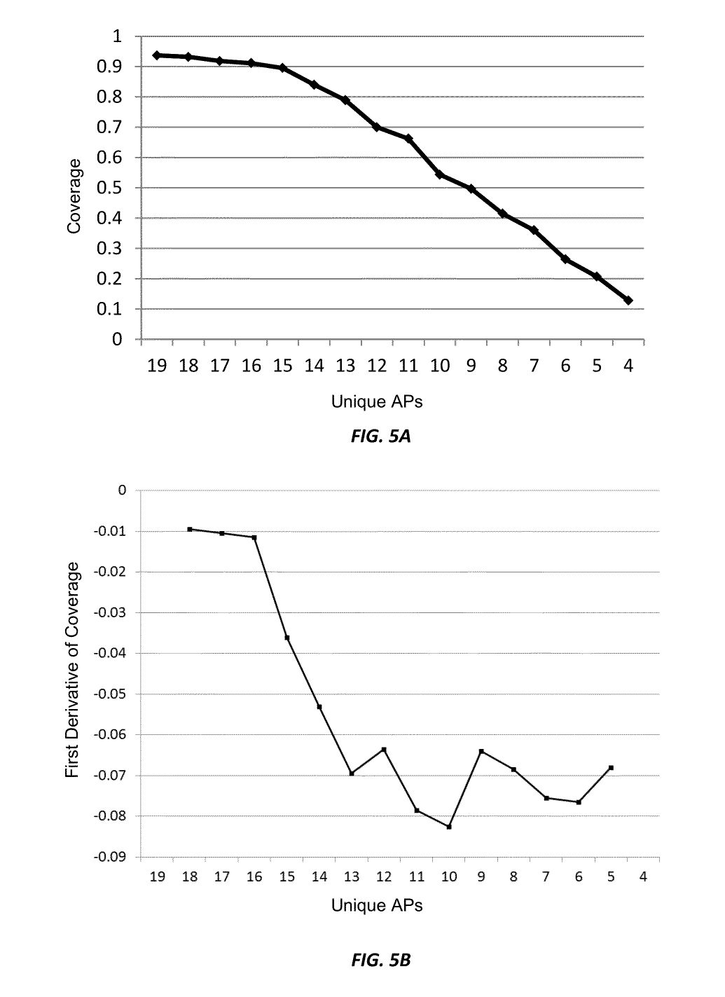

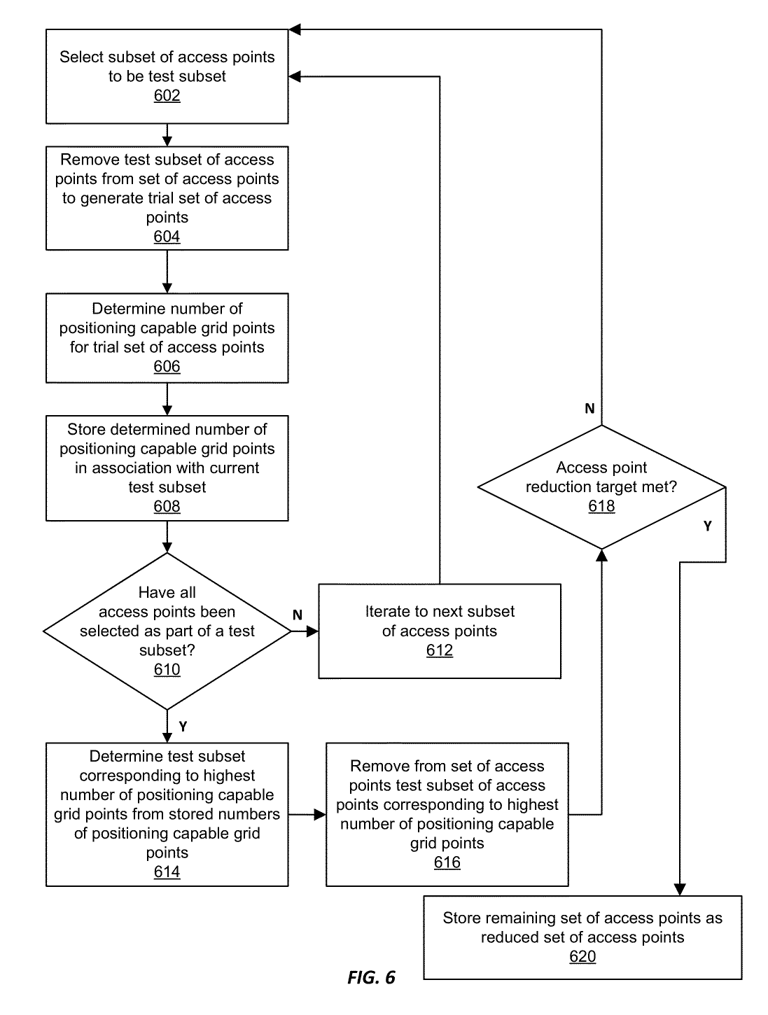

FIG. 5A shows an illustrative coverage drop off point in a graph of coverage ratios corresponding to numbers of access points in reduced sets of APs. In the illustrative example of FIG. 5A, a coverage ratio of 0.94 is shown for a reduced set of APs including 19 unique APs. In other words, for a set of 25 APs, when a reduced set of 19 APs is generated, the ratio of positioning-capable locations for the reduced set of 19 APs to positioning-capable locations for the full set of 25 APs may be 0.94. In the illustrative example of FIG. 5A, coverage ratio remains relatively flat as the number of APs in the reduced set decreases from 19 to 15 and drops off at an increasing rate as the number of APs in the working set decreases from 14 to 4. In this example, the coverage drop off point may be, e.g., 15 APs. When the number of APs in the reduced set drops below 15, it may be determined that a coverage drop off point has been reached, and a target number of APs may be set at 15 APs.

In some embodiments, a coverage drop off point may be a point at which the drop in coverage ratio exceeds some reference threshold. For example, a coverage drop off point may be a point at which a reduction in coverage ratio drops greater than 0.05 for a reduction of one (1) AP. As illustrated in FIG. 5A, such a coverage drop off point occurs at 15 APs. Reducing the number of APs from 15 to 14 causes the coverage ratio to drop more than 0.05.

In another embodiment, a coverage drop off point may be determined based upon a first order derivative for each of multiple points in a graph. For example, a derivative at point in the graph corresponding to 17 APs may be computed as:

$$\frac{( \begin{matrix}Coverage ratio corresponding to 18 APs - \\ Coverage ratio corresponding to 16 APs\end{matrix} )}{2}$$

FIG. 5B shows an illustrative graph of the first derivative of the coverage ratios corresponding to numbers of access points in reduced sets of APs shown in FIG. 5A. A coverage drop off point may be selected to be a point in a graph for which the first order derivative is significantly lower (e.g., lower by a reference factor, e.g., lower by a factor of 1.5-10, such as lower by a factor of 2) than the derivative at a previous point in the graph (that is, a point for which the magnitude of the first order derivative is greater than the first order derivative at a previous point in the graph). For example, if the derivative at a point in the graph corresponding to 16 APs is −0.01 and the derivative at a point in the graph corresponding to 15 APs is −0.04, the derivative at a point in the graph corresponding to 15 APs is lower than the derivative at 16 APs by a factor of 4. Thus, the derivative at a point in the graph corresponding to 15 APs may be determined to be significantly lower than the derivative at 16 APs. Accordingly, 15 APs may be determined to be the coverage drop off point. In yet another example, a coverage drop off point could be determined based upon the number of APs at a local maximum (e.g., the first local maximum, the highest local maximum, etc.) in the graph of the first order derivative. For example, in the graph of FIG. 5B, 12 APs may be chosen as the coverage drop off point on the basis that the value of the first derivative of coverage is the first local maximum. Alternatively, 9 APs may be chosen as the coverage drop off point on the basis that the value of the first derivative of coverage is a local maximum with the highest value.

Whether a target for the reduced set of access points corresponds to a target coverage ratio, a target number of APs, or a coverage ratio drop off point, such target may be based on a desired position accuracy criteria. For example, a mobile device 102 may send one or more accuracy criteria to a server. The target may then be determined based on the accuracy criteria received from the mobile device. For example, accuracy criteria can influence whether a location is definable as positioning-capable. The flow depicted in FIG. 4A then proceeds based upon such a definition of positioning-capable, and continues until the target is met. The server can then transmit, and the mobile device can receive, heat map data for a set APs selected by the server, wherein the set of APs (containing a number of APs that is smaller than the number of APs that the mobile device 102 can hear) is based on the criteria. It is understood that a server 104 can have already determined a plurality of sets of APs that will meet various accuracy criteria and stored such information. In such a scenario, it is understood that the server 104 need not perform a method similar to the method of FIG. 4A after receiving such accuracy criteria from the mobile device 102, but may select a set of APs based on the accuracy criteria from a storage device 1010, such as memory or a database, and transmit to the mobile device 102.

Returning now to FIG. 4A, when the target number is reached, flow may proceed from 416 to 420 such that no further APs are removed from the reduced set of APs.

At operation 418, a current set of APs is iterated to a next subset of APs. For example, the next subset of APs may be a second randomly determined set of APs. Alternatively, the next subset of APs may be a next AP or next set of APs in a sequential list of APs.

At operation 420, the working set of APs may be stored as a reduced set of APs by server 104. When mobile device 102 sends a request for assistance data to server 104, server 104 may respond to the request by sending a list identifying the reduced set of APs to mobile device 102. In addition, or alternatively, heat map data generated for the reduced set of APs may be sent to the mobile device 102, where the heat map data does not include heat map data for APs other than APs in the reduced set. In this way, the amount of data transmitted to the mobile device 102 may be lower than the amount of data sent if heat map data for all APs associated with an area were to be transmitted.

In some embodiments, each reduced set of APs that satisfies the determination of operation 412 and the determination of operation 416 is stored at operation 420. In such embodiments, until all sets of APs have been evaluated, flow proceeds from operation 420 to operation 418. Any of multiple reduced sets of APs stored at 420 may be usable as a reduced set. For example, a first reduced set (e.g., including AP1-AP3, AP6-AP8, AP10-AP13, and AP21-AP25) may satisfy the determination of operation 412 and the determination of operation 416 and a second reduced set (e.g., including AP2, AP4, AP7-AP12, AP14-AP16, and AP18-AP21) may also satisfy the determination of operation 412 and the determination of operation 416. Either of the first reduced set or the second reduced set may be used as a reduced set of APs. For example, a heat map including data for either the first reduced set or the second reduced set may be received by a mobile device 102.

FIG. 4B illustrates operations for receiving a reduced set of access points to be used for mobile device positioning. The operations of FIG. 4B may be performed by a mobile device 102 and/or other computing device.

At operation 452, a list of access points passively scanned by one or more mobile devices (e.g., mobile device 102) may be generated. The list may be generated by mobile device 102, server 104, or another device. The list of access points may correspond to an area, such as a particular room, building, or other environment. Passive scanning is receiving signals, such as beacon signals, from multiple access points, e.g., APs 106-110. Passive scanning may refer to “listening” to data transmitted by APs (as opposed to active scanning, which may involve transmitting requests and receiving responses to the requests).

At operation 454, a heat map is received. The heat map may be received by mobile device 102. The heat map includes heat map data for a reduced set of access points. The reduced set of access points includes fewer access points than the number of access points in the list of access points generated at operation 452. In some embodiments, the reduced set of access points of operation 454 may be a reduced set of access points as stored at operation 420 of FIG. 4A. The heat map data may be used by mobile device 102 to determine a location of mobile device 102.

FIG. 6 illustrates operations for reducing a set of access points to be used for mobile device positioning, according to a second embodiment. Operations 602-620 may be performed by, e.g., server 104.

At operation 602, a subset of APs may be selected from a set of APs. The subset of APs may be a randomly (or pseudorandomly) selected AP or set of APs. Alternatively, subsets of one or more APs may be selected sequentially. The subset of APs may be referred to as a test subset of APs.

At operation 604, the test subset of APs may be removed from the full set of APs to generate a trial set of APs. For example, if a set of APs includes 30 APs identified as AP1-AP30 and the test subset of APs is a single AP identified as AP1, the trial set of APs will include AP2-AP30.

At operation 606, a number of positioning-capable locations (e.g., positioning-capable grid points) is determined for the trial set of APs. In an illustrative example, a number of positioning-capable locations may be determined for trial set of APs including AP2-AP30.

At operation 608, server 104 may store the number of positioning-capable locations determined at operation 606. Server 104 may additionally store the current test subset (e.g., identifiers for the one or more APs in the test subset of APs) in association with the number of positioning-capable locations.

At operation 610, it is determined whether all access points have been selected as part of a test subset of access points. For example, it may be determined whether access points AP1-AP30 have all been selected as part of a test subset. (When an AP is excluded from subsets of APs being trialed for potential removal from the set of APs, e.g., due to AP location as described above, that AP is included in the determination of operation 610. For example, if AP6 is excluded from subsets of APs, operation 610 determines whether AP1-AP5 and AP7-AP30 have all been selected as part of a test subset.) If all subsets of access points have been selected as a test subset, flow may proceed to operation 614. If less than all access points have been selected as a test subset, flow may proceed to operation 612.

At operation 612, a next subset of APs is selected to be a test subset of APs. For example, the next subset of APs may be a next AP or next set of APs in a sequential list of APs. Alternatively, the next subset of APs may be a second randomly determined AP or set of APs. As the flow proceeds through operations 602-608, a number of positioning-capable grid points may be determined for a next trial set of APs. If, according to an example, operation 612 iterates through APs sequentially and one at a time, a number of positioning-capable grid points may be determined for trial sets of APs in which an AP has been removed from each of the trial sets.

At operation 614, server 104 can analyze the numbers of positioning-capable locations corresponding to each of the trial sets as stored at operation 610 and determine the test subset corresponding to the highest number of positioning-capable locations.

At operation 616, server 104 can generate a reduced set of APs by removing from the original set of APs the test subset of APs corresponding to the highest number of positioning-capable grid points as determined at operation 614. In this way, the subset of APs can be determined which, when removed from the set of APs, results in the least reduction of positioning-capable locations. Removing this subset of APs from the set of APs may result in an acceptable reduction of positioning-capable grid points.

At operation 618, it may be determined whether a target for the reduced set of access points is met. A target for the reduced set of access points may be any of various targets as described with reference to FIG. 4A and FIGS. 5A-5B above. If the target for the reduced set of access points is met, flow may proceed to operation 620.

If the target for the reduced set of access points is not met, flow may return to operation 602. When flow returns to operation 602, a subset of APs may be selected from the reduced set of APs generated at operation 616. When flow proceeds to operation 616, a subset of APs determined at 614 may be removed from the previously reduced set of APs previously generated at operation 616.

At operation 620, the reduced set of APs may be stored by server 104. When mobile device 102 sends a request for assistance data to server 104, server 104 may respond to the request by sending a list identifying the reduced set of APs to mobile device 102.

In some embodiments, each reduced set of APs that satisfies the determination of operation 618 is stored at operation 620. In such embodiments, until a condition is met (e.g., all sets of APs have been evaluated), flow proceeds from operation 620 to operation 602. Any of the multiple reduced sets of APs stored at 620 may be usable as the reduced set. For example, the reduced set of APs with the fewest number of APs may be used.

FIG. 7 provides a schematic illustration of one embodiment of a computer system 700 that can perform the methods provided by various other embodiments, as described herein, and/or can function as the host computer system, a remote kiosk/terminal, a point-of-sale device, a mobile device, and/or a computer system. FIG. 700 is meant only to provide a generalized illustration of various components, any or all of which may be utilized as appropriate. FIG. 700, therefore, broadly illustrates how individual system elements may be implemented in a relatively separated or relatively more integrated manner.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics acceleration processors, and/or the like); one or more input devices 706, which can include without limitation a mouse, a keyboard and/or the like; and one or more output devices 708, which can include without limitation a display device, a printer and/or the like.

The computer system 700 may further include (and/or be in communication with) one or more non-transitory storage devices 710, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth® device, an 802.11 device, a Wi-Fi device, a WiMax device, cellular communication facilities, etc.), and/or similar communication interfaces. A computing system may include one or more antennas for wireless communication as part of communications subsystems 712 or as a separate component coupled to any portion of the system. The communications subsystem 712 may permit data to be exchanged with a network (such as the network described below, to name one example), other computer systems, and/or any other devices described herein. In many embodiments, the computer system 700 will further comprise a non-transitory working memory 714, which can include a RAM or ROM device, as described above.

The computer system 700 also can comprise software elements, shown as being currently located within the working memory 714, including an operating system 716, device drivers, executable libraries, and/or other code, such as one or more application programs 718, which may comprise computer programs provided by various embodiments, and/or may be designed to implement methods, and/or configure systems, provided by other embodiments, as described herein. Merely by way of example, one or more procedures and/or modules described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 710 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an system configured to provide some or all of the features described herein can comprise hardware and/or software that is specialized (e.g., an application-specific integrated circuit (ASIC), a software method, etc.) or generic (e.g., processor(s) 704, applications 718, etc.) Further, connection to other computing devices such as network input/output devices may be employed.

Some embodiments may employ a computer system (such as the computer system 700) to perform methods in accordance with the disclosure. For example, some or all of the procedures of the described methods, such as the operations discussed with regard to FIGS. 4A-4B and FIG. 6, may be performed by the computer system 700 in response to processor 704 executing one or more sequences of one or more instructions (which might be incorporated into the operating system 716 and/or other code, such as an application program 718) contained in the working memory 714. Such instructions may be read into the working memory 714 from another computer-readable medium, such as one or more of the storage device(s) 710. Merely by way of example, execution of the sequences of instructions contained in the working memory 714 might cause the processor(s) 704 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 704 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 710. Volatile media include, without limitation, dynamic memory, such as the working memory 714. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 712 (and/or components thereof) generally will receive the signals, and the bus 702 then might carry the signals (and/or the data, instructions, etc. carried by the signals) to the working memory 714, from which the processor(s) 704 retrieves and executes the instructions. The instructions received by the working memory 714 may optionally be stored on a non-transitory storage device 710 either before or after execution by the processor(s) 704.

FIG. 8 illustrates an example of a mobile device, according to some embodiments. Mobile device 102 may be a mobile device as described with regard to FIG. 8. Mobile device 800 includes a processor 810, and a memory 820. Mobile device 800 may use processor 810 configured to execute instructions for performing operations at a number of components and can be, for example, a general-purpose processor or microprocessor suitable for implementation within a portable electronic device. Processor 810 is communicatively coupled with a plurality of components within mobile device 800. To realize this communicative coupling, processor 810 may communicate with the other illustrated components across a bus 840. Bus 840 can be any subsystem adapted to transfer data within mobile device 800. Bus 840 can be a plurality of computer buses and include additional circuitry to transfer data.

Memory 820 may be coupled to processor 810. In some embodiments, memory 820 offers both short-term and long-term storage and may in fact be divided into several units. Memory 820 may be volatile, such as static random access memory (SRAM) and/or dynamic random access memory (DRAM) and/or non-volatile, such as read-only memory (ROM), flash memory, and the like. Furthermore, memory 820 can include removable storage devices, such as secure digital (SD) cards. Thus, memory 820 provides storage of computer readable instructions, data structures, program modules, and other data for mobile device 800. In some embodiments, memory 820 may be distributed into different hardware modules. Instructions for operations described with regard to FIGS. 4A-4B and FIG. 6 may be stored by memory 820.

In some embodiments, memory 820 stores a plurality of application modules 821 through 822, which may be any number of applications. Application modules contain particular instructions to be executed by processor 810. In alternative embodiments, other hardware modules 801 may additionally execute certain applications or parts of applications 821-822. In certain embodiments, memory 820 may additionally include secure memory, which may include additional security controls to prevent copying or other unauthorized access to secure information.

In some embodiments, memory 820 includes an operating system 823. Operating system 823 may be operable to initiate the execution of the instructions provided by application modules 821-822 and/or manage other hardware modules 801 as well as interfaces with communication modules which may use wireless transceiver 812. Operating system 823 may be adapted to perform other operations across the components of mobile device 800 including threading, resource management, data storage control and other similar functionality.

In some embodiments, mobile device 800 includes a plurality of other hardware modules 801. Each of other hardware modules 801 is a physical module within mobile device 800. However, while each of hardware modules 801 is permanently configured as a structure, a respective one of hardware modules 801 may be temporarily configured to perform specific functions or temporarily activated. A common example is an application module that may program a camera module (i.e., hardware module) for shutter release and image capture. A respective one of hardware modules 801 can be, for example, an accelerometer 830, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 801-802 may be implemented in software.

Mobile device 800 may include a component such as wireless communication module which may integrate antenna 814 and wireless transceiver 812 with any other hardware, firmware, or software necessary for wireless communications. Such a wireless communication module may be configured to receive signals from various devices such data sources via networks, access points, base stations, satellite vehicles, and the like, such as base stations 104-108.

In addition to other hardware modules 801 and application modules 821-822, mobile device 800 may have a display module 803 and a user input module 804. Display module 803 graphically presents information from mobile device 800 to the user. This information may be derived from one or more application modules 821, one or more hardware modules 801, a combination thereof, or any other suitable means for resolving graphical content for the user (e.g., by operating system 823). Display module 803 can be liquid crystal display (LCD) technology, light emitting polymer display (LPD) technology, or some other display technology. In some embodiments, display module 803 is a capacitive or resistive touch screen and may be sensitive to haptic and/or tactile contact with a user. In such embodiments, the display module 803 can comprise a multi-touch-sensitive display.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A computer-implemented method for reducing a set of access points to be used for mobile device positioning, comprising:
selecting a subset of access points from a set of access points, wherein the subset of access points includes one or more access points but less than all access points of the set of access points;
generating a trial set of access points by removing the subset of access points from the set of access points;
determining whether a coverage quality for the trial set of access points exceeds a threshold coverage quality; and
in response to determining that the coverage quality for the trial set of access points exceeds the threshold coverage quality, removing the subset of access points from the set of access points.

2. The method of claim 1, wherein determining whether the coverage quality for the trial set of access points exceeds the threshold coverage quality comprises:
determining a number of positioning-capable locations within an area using the trial set of access points; and
determining a number of positioning-capable locations within the area for the set of all access points;
wherein the coverage quality is a ratio of the number of positioning-capable locations for the trial set of access points to the number of positioning-capable locations for the set of all access points.

3. The method of claim 2, wherein determining the number of positioning-capable locations comprises determining whether a location in the area is a positioning-capable location, wherein determining whether a location is a positioning-capable location includes determining at least one of:
whether a horizontal dilution of precision (HDOP) for a given set of access points falls below a threshold HDOP value at the location;
whether a received signal strength indicator (RSSI) from at least three access points from the given set of access points exceeds a threshold RSSI value at the location; and
whether a round trip time (RTT) from at least three access points of the given set of access points falls below a threshold RTT value at the location, or any combination thereof,
wherein the given set of access points is one of the set of all access points in the area or the trial set of access points.

4. The method of claim 1, further comprising:
repeating the selecting, generating, determining, and removing until a target for a reduced set of access points is reached; and
generating the reduced set of access points.

5. The method of claim 4, wherein the target for the reduced set of access points is a target coverage ratio, wherein the target coverage ratio is a ratio of a number of positioning-capable locations for the reduced set of access points to a number of positioning-capable location for the set of all access points.

6. The method of claim 5, wherein the target for the reduced set of access points is determined using a coverage drop off point in a target coverage ratio as the number of access points in the reduced set of access points is decreased.

7. The method of claim 4, wherein the target for the reduced set of access points is a target number of access points.

8. The method of claim 1, wherein the subset of access points is selected randomly, pseudorandomly, sequentially, or any combination thereof.

9. The method of claim 1, further comprising identifying at least one access point as an access point that is not selectable for the subset of access points.

10. The method of claim 1, further comprising generating a reduced set of access points and sending information identifying the reduced set of access points to a mobile device.

11. A mobile device comprising:
a processor;
a computer-readable storage device coupled to the processor; and
one or more programs, wherein the one or more programs are stored in the computer-readable storage device and configured to be executed by the processor, the one or more programs including instructions for:
generating a list of a plurality of access points passively scanned by the mobile device; and
receiving, from a server, heat map data for a reduced set of access points, wherein the reduced set of access points has fewer access points than the plurality of access points of the list.

12. The mobile device of claim 11, wherein the mobile device uses the heat map data to determine a location of the mobile device.

13. The mobile device of claim 11, wherein the reduced set of access points is selected from a set of all access points in the area by:
selecting a subset of access points from the set of all access points in the area, wherein the subset of access points is one or more but less than the set of all access points;
generating a trial set of access points by removing the subset of access points from the set of access points;
determining whether a coverage quality for the trial set of access points exceeds a threshold coverage quality, wherein the coverage quality is a ratio of a number of positioning-capable locations for the trial set of access points to a number of positioning-capable locations for the set of all access points; and
in response to determining that the coverage quality for the trial set of access points exceeds the threshold coverage quality, removing the subset of access points from the set of access points.

14. The mobile device of claim 13, wherein determining whether a location is a positioning-capable location includes determining at least one of:
whether a horizontal dilution of precision (HDOP) for a given set of access points falls below a threshold value at the location;
whether a received signal strength indicator (RSSI) from at least three access points from the given set of access points exceeds a threshold value at the location; and
whether a round trip time (RTT) from at least three access points from the given set of access points falls below a threshold value at the location,
wherein the given set of access points is one of the set of all access points in the area or the trial set of access points.

15. The mobile device of claim 11, wherein the one or more programs further include instructions for repeating the selecting, generating, determining, and removing until a target for the reduced set of access points is reached.

16. The mobile device of claim 15, wherein the target for the reduced set of access points is at least one of:
a target coverage ratio, wherein the target coverage ratio is a ratio of a number of positioning-capable locations for the reduced set of access points to a number of positioning-capable location for the set of all access points;
a target determined using a coverage drop off point; or
a target number of access points.

17. A non-transitory computer-readable storage medium comprising a computer program product of computer-readable instructions for performing a method of reducing a set of access points to be used for mobile device positioning, the method comprising:
selecting a subset of access points from a set of access points, wherein the subset of access points includes one or more access points but less than all access points of the set of access points;
generating a trial set of access points by removing the subset of access points from the set of access points;
determining whether a coverage quality for the trial set of access points exceeds a threshold coverage quality; and
in response to determining that the coverage quality for the trial set of access points exceeds the threshold coverage quality, removing the subset of access points from the set of access points.

18. The non-transitory computer-readable storage medium of claim 17, wherein the method further comprises:
determining a number of positioning positioning-capable locations within an area using the trial set of access points; and
determining a number of positioning-capable locations within the area for the set of all access points;
wherein the coverage quality is a ratio of the number of positioning-capable locations for the trial set of access points to the number of positioning-capable locations for the set of all access points.

19. The non-transitory computer-readable storage medium of claim 17, wherein the method further comprises repeating the selecting, generating, determining, and removing until a target for a reduced set of access points is reached; and
generating the reduced set of access points.

20. The non-transitory computer-readable storage medium of claim 19, wherein the target for the reduced set of access points is at least one of:
a target coverage ratio, wherein the target coverage ratio is a ratio of a number of positioning-capable locations for the reduced set of access points to a number of positioning-capable location for the set of all access points;
a target determined using a coverage drop off point; or
a target number of access points.
